(19) United States
(12) Patent Application Publication
(10) Pub. No.: US 2008/0030350 A1
(43) Pub. Date: Feb. 7, 2008

(54) Cell phone panic button

(76) Inventor: George Brenner, North Richland Hills, TX (US)

Correspondence Address: WILSON DANIEL SWAYZE, JR., 3804 CLEARWATER CT., PLANO, TX, 75025, US

(21) Appl. No.: 11/499,539

(22) Filed: Aug. 4, 2006

(51) Int. Cl. G08B 13/00; H04M 11/04

(52) U.S. Cl. 340/574; 455/404.1

(57) ABSTRACT

A mobile communication terminal for communication includes a panic button to generate a loud audible signal and a speaker connected to the panic button to broadcast the loud audio signal as a loud audio sound.

### FIELD OF THE INVENTION

The present invention relates to a mobile communication terminal such as a mobile telephone or PDA (Personal Digital Assistant), and particularly to a mobile communication terminal that includes a panic button. FIG. 1 illustrates a typical prior art emergency reporting arrangement using a telephone 10. A person in need of emergency help dials a designated emergency reporting number (e.g., ‘911’) to connect to an emergency service center (ESC) 12. The emergency service center 12 may be a 911 response center, a police station, a hospital, a fire station, a combination of these places or any other location equipped for dispatching emergency relief. A carrier network 14 may electrically connect the telephone 10 to a receiving apparatus (e.g., an operator headset receiver) at the ESC 12. The carrier network 14 may include, individually or in combination, the plain old telephone system (POTS), the more advanced public switched telephone network (PSTN), or a wireless communication network (e.g., a cellular phone network) when the telephone 10 is, for example, a cellular phone (“cell phone”). reporting number (e.g., ‘9’, ‘1’, ‘1’), a user may instead “speed dial” the number by programming a single key on the telephone 10. In this manner, the user need not press individual digits of the phone number, but, instead, may need to press only a pre-marked speed dial key. Some modern cell phones come equipped with a “button” or key on their keypads that is dedicated to dial a predetermined emergency phone number (e.g., ‘911’).

Another emergency reporting device is shown in FIG. 2, which depicts a prior art “panic button” 16 in communication with the emergency service center 12. The panic button 16 may be broadly categorized as a wearable wireless transmitter that finds applications in situations when the user may not easily access the telephone 10 or when the user is not able to dial the ESC's 12 telephone number. Users of the panic button 16 may include, among others, elderly people and people with delicate health. Normally, the user wears the panic button 16 around the user's neck and presses the panic button when an emergency condition arises. The panic button 16 wirelessly transmits an “alarm signal” to a base unit or receiving device (not shown) attached to the user's phone line. The alarm signal instructs the base unit to initiate a phone call to a preprogrammed phone number, usually the phone number of an establishment or company that provides support services and maintenance for such panic buttons in a given geographical area.

A support service provider (SSP) 18 receives the phone call from the base unit of the panic button 16 via the carrier network 14. The base unit may send over the phone line an identification code or number pre-assigned to the panic button 16 by the SSP 18. Therefore, an operator at the SSP 18 may immediately compare the received identification code with a customer database to identify the user of the panic button 16. Upon identifying the user, the operator in the SSP's 18 facility may place a phone call to the ESC 12 giving requisite information (e.g., the name of the person in distress, the location where help is needed, any known medical history of the person requiring emergency help, etc.) to the operator or relief help dispatcher at the ESC 12. All such information may be stored in the SSP's 18 customer database (not shown) when the panic button 16 is assigned to a particular user. Instead of manual database look-up, the SSP 18 may implement an automatic database search and comparison process to instantly identify the operator of the panic button 16 as soon as an alarm indication is received from the base unit.

Normally, the carrier network 14 in the panic button application of FIG. 2 is a wireline network, e.g., the POTS or the PSTN. However, in a situation involving close monitoring of the elderly or the disabled (e.g., monitoring of patients in a large hospital complex), the panic button technology may be employed via a local wireless carrier network 14. The patient may activate the personal panic button 16 and the carrier network 14 may wirelessly transfer the help request to appropriate staff or emergency relief personnel in the hospital's ESC 12. The SSP 18 may not be needed in such an environment as symbolically indicated by the direct dotted connection between the panic button 16 and the ESC 12.

From the foregoing, it can be observed that the prior art devices used to report emergency conditions (e.g., the telephone 10 in FIG. 1 and the panic button 16 in FIG. 2) primarily send emergency help request messages through telephone signals in a circuit-switched telephone environment, i.e., in a telephone environment that “dedicates” an actual physical circuit between the caller and the called party. This “traditional” approach to request emergency help by calling ‘911’ may not be effective sometimes, for example, when the person in need of help is in need of help because there is an intruder entering the dwelling or there is an approaching attacker. Under these circumstances, there is a need to deter the intruder or attacker immediately. With the popularity of the cell phone today, most people will carry a cell phone at all times. There is a need to be able to use this cell phone in order to deter the attacker or intruder in immediately. The use of panic buttons are described in U.S. Pat. Nos. 7,046,140, 6,681,120 and 5,877,724.

### BRIEF SUMMARY

An object of the present invention is to provide a mobile communication terminal which includes a speaker and panic button to produce a loud audible signal and sound when the panic button has been pressed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 illustrates a carrier network and emergency service center;

FIG. 2 illustrates a support service provider, carrier network and emergency service center;

FIG. 3 illustrates a mobile communication terminal according to a first embodiment of the invention;

FIG. 4 illustrates a block diagram showing the circuit structure of the mobile communication terminal shown in FIG. 3.

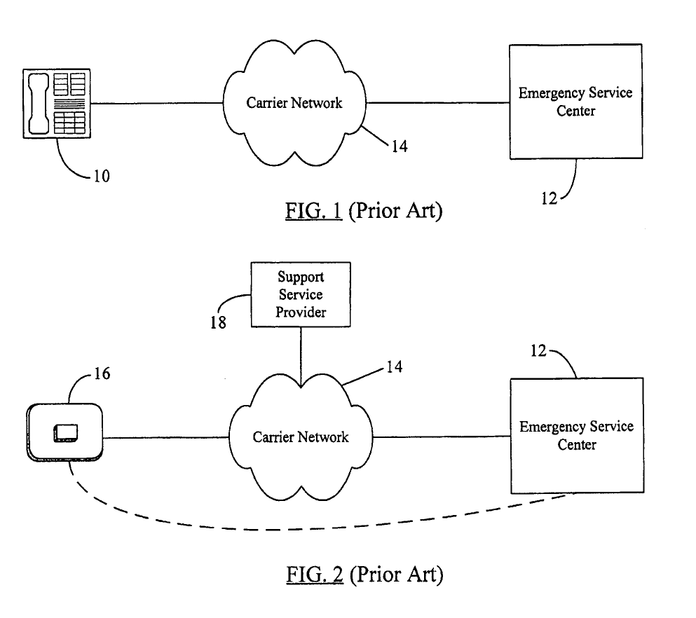

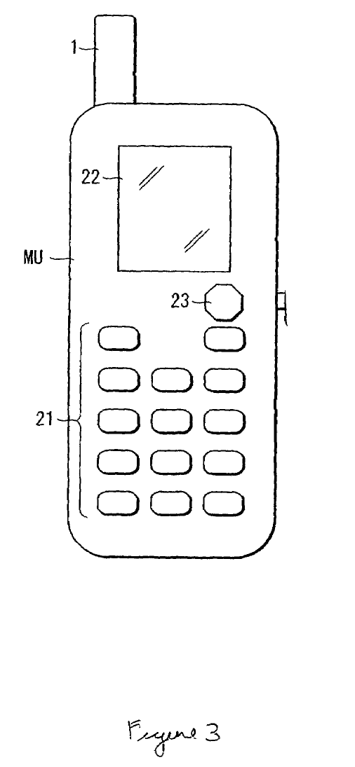

### DETAILED DESCRIPTION OF THE INVENTION

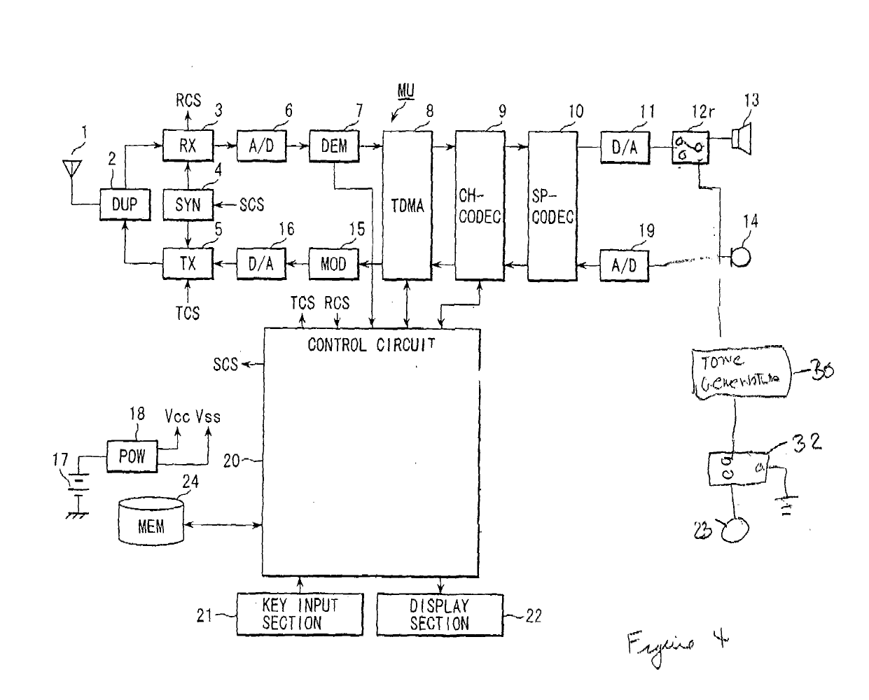

FIG. 3 shows a mobile communication terminal, and the mobile communication terminal includes a rectangular-shaped housing and a panic button incorporated in the housing.

On the front of the box-shaped housing, a key input section 21, a display section 22, and a panic button 23 are provided. An antenna 1 is provided on the upper part of the housing. Moreover, an earphone jack is provided in a side of the housing.

FIG. 4 is a block diagram showing the circuit structure of the mobile communication terminal MU.

As FIG. 4 shows, the antenna receives a radio signal transmitted a base station (not shown) via a radio channel. In the terminal MU, the radio signal is input to a receiving circuit (RX) 3 via a duplexer (DUP) 2. The receiving circuit 3 mixes the radio signal with a local oscillation signal, thus down-converting the radio signal to an intermediate-frequency signal. The local oscillation signal has been generated by a frequency synthesizer (SYN) 4, which is controlled by a control SCS output from a control circuit 20. An A/D converter 6 including a low-pass filter converts the intermediate-frequency signal to a digital signal. The digital signal is input to a digital demodulation circuit (DEM) 7.

The digital demodulation circuit 7 performs frame synchronization and bit synchronization on the digital affix intermediate-frequency signal. The circuit 7 demodulates the digital intermediate-frequency signal, generating a base-band signal. The base-band signal is input to a TDMA (Time Division Multiple Access) circuit 8. The TDMA circuit 8 extracts a timeslot from each transmission frame of the base-band signal. Information about the frame synchronization and the bit synchronization, acquired at the above-mentioned digital demodulation circuit 7, is notified to the control circuit 20.

The base-band signal extracted from the TDMA circuit 8 is input to a channel codec (CH-CODEC) 9. In the channel codec 9, the base-band signal undergoes error correction decoding. In a data communication mode, information data such as an e-mail is inserted into the base band signal. In a speech mode, speech data is inserted into the base band signal.

The speech data is input to the speech codec (SP-CODEC) 10. The speech codec 10 performs a voice decoding process on the base-band signal, reproducing a digital call-receiving signal. A D/A converter 11 converts the digital call-receiving signal into an analog call-receiving signal. The analog call-receiving signal is input to a speaker amplifier (not shown) through a switching circuit 12r. Then, the analog call-receiving signal is supplied to a speaker 13. The speaker amplifier provided in the speaker 13 amplifies the signal. The signal amplified is output from the speaker 13.

The information data, such as an e-mail or downloaded data, is input to the control circuit 20. The control circuit 20 stores the information data into a memory (MEM) 24, while decoding the data and displaying the data on the display section 22.

Meanwhile, a user inputs a call-sending signal into a microphone 14. The amplifier (not shown) incorporated in the microphone 14 amplifies the call-sending signal. The call-sending signal amplified is input to an A/D converter 19. The A/D converter 19 converts the signal into a digital call-sending signal. The speech codec (SP-COD) 10 performs voice decoding on the digital call-sending signal. More precisely, the echo canceller (not shown) provided in the speech codec 10 cancels the echo component of the signal. Transmission data is thereby acquired.

The transmission data is input to the channel codec (CH-COD) 9. The codec 9 carries out error correction coding on the transmission data. The information data, such as the picture data or the e-mail, output from the control circuit 20 is input to the channel codec 9, too. The information data undergoes the error correction coding. The transmission data output from the channel codec 9 is input to the TDMA circuit 8. The TDMA circuit 8 forms a TDMA transmission frame. Then, the TDMA circuit 8 inserts the transmission data into the timeslot assigned to the mobile communication terminal MU and contained in the formed TDMA transmission frame. The TDMA circuit 8 generates data, which is input to the digital modulation circuit (MOD) 15.

The digital modulation circuit 15 implements digital modulation to the transmission data. The transmission data modulated is input to a D/A converter 16. The converter 16 converts the transmission data into an analog signal. The analog signal is supplied to a transmitting circuit (TX) 5. The digital modulation that the circuit 15 performs is, for example, .pi./4 shift DQPSK (.pi./4 shifted, differentially encoded quadrature phase shift keying) method.

The transmitting circuit 5 mixes the demodulated transmission data with the local oscillation signal, thereby up-converting the demodulated transmission data into a radio signal. A transmission power amplifier (not shown) amplifies the radio signal to a predetermined transmission power level. The radio signal so amplified is supplied to the antenna 1 via the duplexer 2. The antenna 1 transmits the radio signal toward the base station (not shown).

As indicated above, the mobile communication terminal MU comprises the key input section 21, the display section 22, and the panic button 23. When the panic button 23 is pushed by the user, the switching circuit 32 activates the tone generator 30 to generate a loud audible tone which is heard through speaker 13. As a consequence, any intruder or attacker will hear the loud audible tone and realize that he/she has been discovered and be deterred from further adverse actions.

The present invention can also be applied to mobile information assistants (PDAs), mobile audio players, portable navigation devices, watches and the like, as well as mobile telephones or PHS terminals.

Various changes and modifications can be made without departing from the scope and spirit of the invention, in the type of the mobile communication terminal (one for TDMA system, another for CDMA system), the shape an structure of the earphone unit and flash unit, the structure of the earphone jack, the structure of the plug of either external unit, the method of identifying the external unit coupled to the earphone jack, the method of switching the radio path, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1) A mobile communication terminal for communication, comprising:
a panic button to generate a loud audible signal; and
a speaker connected to said panic button to broadcast said loud audio signal as a loud audio sound.

2) A mobile communication terminal for communication as in claim 1, wherein said mobile connected terminal is a mobile phone.

3) A mobile communication terminal for communication as in claim 1, wherein said mobile connected terminal is a cell phone.

4. A mobile communication terminal for communication as in claim 1, wherein said mobile connected terminal is a personal digital assistant.
